(19) United States
(12) Patent Application Publication
(10) Pub. No.: US 2021/0167358 A1
(43) Pub. Date: Jun. 3, 2021

(54) HETEROATOM CONTAINING CARBON-BASED MATERIALS

(71) Applicant: Sparkle Power LLC, Rochester, NY (US)

(72) Inventors: Huanlei Wang, Edmonton (CA); David Mitlin, Hannawa Falls, NY (US)

(21) Appl. No.: 17/110,748

(22) Filed: Dec. 3, 2020

Related U.S. Application Data
(60) Provisional application No. 62/942,912, filed on Dec. 3, 2019.

(51) Int. Cl. H01M 4/133; H01M 4/1393; H01M 10/054; C01B 32/05

(52) U.S. Cl. CPC H01M 4/133; H01M 4/1393; H01M 2004/027; C01B 32/05; H01M 10/054

(57) ABSTRACT

A carbon-based material including at least two heteroatoms, wherein at least one of the at least two heteroatoms is covalently bonded to carbon in the carbon-based material. An electrode including the carbon-based material, and a process for synthesizing the carbon-based material.

### CROSS REFERENCE TO RELATED APPLICATIONS

The present application claims priority to co-pending U.S. Provisional Application No. 62/942,912 filed on Dec. 3, 2019 and entitled “Battery Electrodes with Fast Charge and High Capacity from Dual Doped Sulfur-Nitrogen Rich Carbon”, the entirety of which is incorporated by reference herein.

### FIELD OF THE INVENTION

The present invention relates to heteroatom containing carbon-based materials, and more particularly to heteroatom containing carbon-based materials used as electrodes in electrochemical energy storage devices.

### BACKGROUND OF THE INVENTION

Large-scale energy storage systems play a key role in advancing smart power grid and other stationary and municipal renewable energy storage applications. Lithium-ion batteries (LIBs) may become restricted for such large-scale application due to limited supply of Li precursors and of cobalt (Co) used in most LIB cathodes.

In view of the abundance and low cost of potassium precursors, potassium ion batteries (PIBs, KIBs) are considered a potential alternative to LIBs for applications. However, many well-established anode materials in LIBs are poorly suitable for KIBs. One example is graphite, which performs badly with potassium due to the larger ionic size of K⁺ (1.38 Å) relative to Li⁺ (0.76 Å), and a difference in the ion-carbon bonding. The potassium ion will cause too large of volume expansion during charging, leading to low capacity especially at higher charge rates, as well as poor cyclability.

However, with electrode materials tuned specifically for hosting K⁺ rather than Li⁺, KIBs may be a promising alternative. The present invention is provided to address at least the needs mentioned herein and provide a possible alternative to known materials.

### SUMMARY OF THE INVENTION

One aspect of the invention is directed to a carbon-based material. In particular, the carbon-based material is used for an electrode for a KIB, i.e., the electrode is a carbon-based electrode. The carbon-based electrode has high capacity, increased rate capability and high cycling performance as compared to known KIB electrodes. In one embodiment, the carbon-based material includes heteroatoms.

One embodiment of the invention is directed to an electrode for an electrochemical energy storage device, comprising: a carbon-based material comprising at least two heteroatoms, wherein at least one of the at least two heteroatoms is covalently bonded to carbon in the carbon-based material.

In one embodiment, the at least two heteroatoms are selected from a group consisting of boron (B), oxygen (O), sulfur (S), phosphorus (P) and nitrogen (N). In a particular embodiment, the at least two heteroatoms are sulfur (S) and nitrogen (N), and more particularly comprises 12.3 at. % S and 10.0 at. % N. In one example, sulfur is covalently bonded to carbon in the carbon-based material. In one embodiment, the electrode comprises 75% retention of initial capacity after 3000 cycles.

In one embodiment, the electrode is used in the electrochemical energy storage device is a potassium ion battery (KIB), in particular, as an anode.

Another aspect of the invention is directed to a carbon-based material comprising at least two heteroatoms, wherein at least one of the at least two heteroatoms is covalently bonded to carbon in the carbon-based material. In one embodiment, the at least two heteroatoms are selected from a group consisting of boron (B), oxygen (O), sulfur (S), phosphorus (P) and nitrogen (N). In a particular embodiment, the at least two heteroatoms are sulfur (S) and nitrogen (N) and more particularly 12.3 at. % S; and 10.0 at. % N. In one embodiment, sulfur is covalently bonded to carbon in the carbon-based material. The carbon-based material, in one embodiment, further comprises macropores and mesopores, wherein the macropores and mesopores are filled with sulfur.

Another aspect of the invention is directed to a process for synthesizing a heteroatom-containing carbon material, the process comprising: carbonizing a polymer salt precursor to form a nitrogen-rich carbon material; and introducing sulfur to the nitrogen-rich carbon material by a reaction between sodium thiosulfate and dilute hydrochloride acid, thereby synthesizing the heteroatom-containing carbon material. In one embodiment of the process, the polymer salt precursor is a poly(acrylamide-co-acrylic acid) potassium salt-sulfur precursor. In a further embodiment of the process, the sulfur covalently bonds to carbon in the nitrogen-rich carbon material.

A particular embodiment of the invention is directed to a dual “doped” carbon material. In one aspect, the dual doped carbon material is carbon doped with sulfur (S) and nitrogen (N), also referred to as “an S-doped N-rich carbon”. The S-doped N-rich carbon is, in one embodiment, synthesized by carbonizing a poly (acrylamide-co-acrylic acid) potassium salt-sulfur precursor. Elemental sulfur is introduced into the polymer salt through a reaction between sodium thiosulfate and dilute hydrochloride acid. In one aspect, the S-doped N-rich carbon comprises a uniquely large dual content of S (12.3 at. %) and N (10.0 at. %), and demonstrates exceptional reversible K storage capability, superior rate performance and excellent cyclic stability.

Combinations of any of the foregoing aspects, embodiments, and/or examples, and portions thereof, are contemplated and are within the scope of the instant invention.

### BRIEF DESCRIPTION OF THE DRAWINGS

FIG. 1 is a scanning electron microscope (SEM) image of a carbon-based material according to embodiments described herein.

FIG. 2 is a front cross section of an electrochemical energy storage device.

FIG. 3 is a schematic of a process according to embodiments described herein.

### DETAILED DESCRIPTION OF THE INVENTION

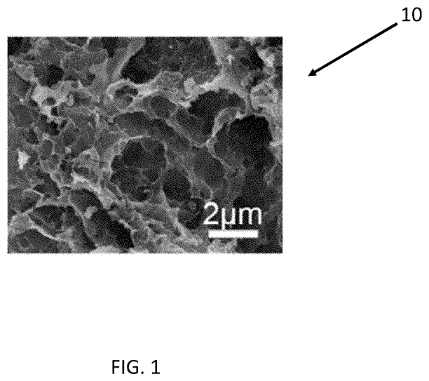

In one aspect, as shown in FIG. 1, the present invention provides a carbon-based material 10. The carbon-based material 10 includes at least two heteroatoms. The heteroatoms included in the carbon-based material 10 may be any known heteroatoms. In a specific embodiment, the at least two heteroatoms are selected from boron (B), oxygen (O), sulfur (S), phosphorus (P) and nitrogen (N). In a specific example, the carbon-based material 10 includes sulfur (S) and nitrogen (N). The carbon-based material 10 may be referred to as “S—NC”.

It is contemplated that the carbon-based material 10 includes any amount, percentage, or concentration of heteroatoms. In one embodiment, each of the at least two heteroatoms is present at a similar atomic percent (at. %). In another embodiment, each of the at least two heteroatoms is present at different at. %. In one example, the first heteroatom and second heteroatom are each independently present between 5.0 at. % to 15.0 at. %; between 7.0 at. % to 12.0 at. %; 8.0 at. % to 10.0 at. %, and any value therebetween.

In one embodiment of the carbon-based material 10, the heteroatoms are sulfur (S) and nitrogen (N), where sulfur is present between 10.0 at. % to 15.0 at. % and nitrogen is present between 8.0 at. % and 12.0 at. %. In another embodiment, the carbon-based material 10 includes 11.0 at. % to 12.5 at. % sulfur and 9.0 at. % to 10.5 at. % nitrogen. In a particular embodiment, the carbon-based material 10 includes 12.3 at. % sulfur; and 10.0 at. % nitrogen.

It has been found that at least one of the heteroatoms present in the carbon-based material is covalently bonded to carbon. In particular, it has been found that sulfur (S) covalently bonds to carbon in the carbon-based material.

In one embodiment, the carbon-based material 10 includes pores in the surface thereof. In particular, the pores are macropores and mesopores. At least a portion of the macropores and mesopores are filled with the heteroatoms, i.e., at least 25% of the pores are filled, at least 35% of the pores are filled, at least 40% of the pores are filled, at least 50% of the pores are filled, at least 60% of the pores are filled, at least 70% of the pores are filled, at least 80% of the pores are filled, at least 85% of the pores are filled, at least 90% of the pores are filled, at least 92% of the pores are filled, at least 95% of the pores are filled, at least 99% of the pores are filled, at least 100% of the pores are filled, based on the entire amount of pores in the carbon-based material 10. In a particular embodiment, the carbon-based material is nitrogen rich and has sulfur present in at least a portion of its macropores and mesopores.

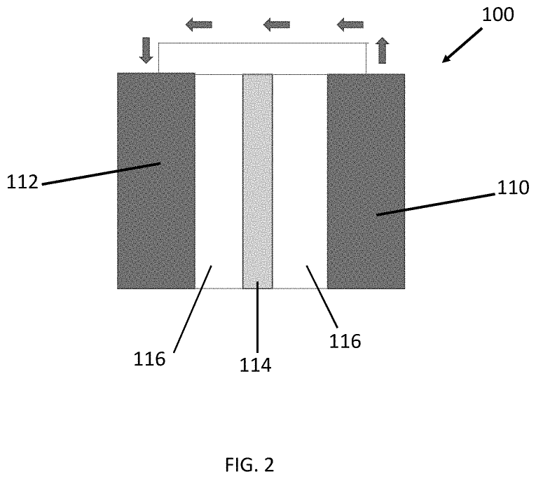

In one embodiment, the invention includes an electrode for an electrochemical energy storage device 100, as shown in FIG. 2. The electrode includes the carbon-based material 10 (not illustrated on FIG. 2). The electrode having the carbon-based material 10 has high capacity, increased rate capability and high cycling performance as compared to known electrodes, e.g., electrodes used in KIBs. In one embodiment, the carbon-based material 10 is used as an electrode in the electrochemical energy storage device 100.

As shown in FIG. 1, the device 100 includes two electrodes: an anode 110 and a cathode 112. In the particular embodiment shown in FIG. 1, the device 100 also includes a separator 114 disposed between the anode 110 and the cathode 112 and an electrolyte 116 in physical contact with both the anode 110 and the cathode 112. In one embodiment, the device 100 is a KIB.

The electrode, i.e., the anode 110 and/or cathode 112, includes the carbon-based material 10 according to embodiments described herein. It is contemplated that the anode 110 and the cathode 112 may include other material(s) that are readily known and used in anodes and cathodes, e.g., hard carbon, graphite, other carbon-based material, additives, metallic-based materials, support structures, and the like. In one embodiment, one electrode includes the carbon-based material 10 according to embodiments disclosed herein and the counter electrode is potassium foil.

The electrolyte 116 may be organic, ionic liquid, aqueous, or a combination. Standard battery and supercapacitor electrolytes are contemplated. In one embodiment, the electrolyte is a solution of 0.8M KPF₆ in ethylene carbonate (EC) and diethyl carbonate (DEC) (1:1 by volume). Separator 114 may be in accordance with standard battery separators.

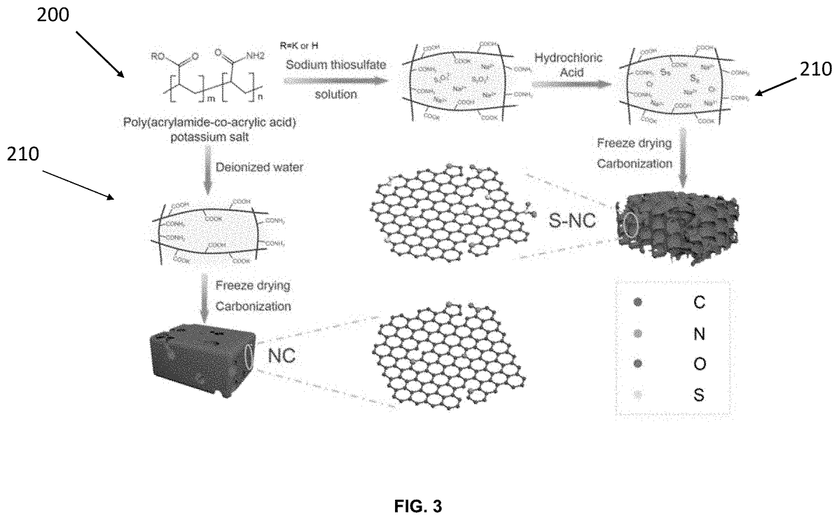

FIG. 3 illustrates a process 200 for synthesizing a heteroatom-containing carbon material, such as, for example, the carbon-based material 10. In one embodiment, the process 200 includes a step 210, which includes carbonizing a polymer salt precursor. As shown in FIG. 3, in one embodiment, two types of carbon-based materials are formed: a carbon-based material 10 with two heteroatoms, sulfur and nitrogen (denoted as “S—NC”), and a control material that only includes nitrogen, but does not include sulfur (denoted as “NC”).

To form NC, a polymer salt precursor such as a poly(acrylamide-co-acrylic acid) potassium salt-sulfur precursor is carbonized. While FIG. 3 indicates the carbonization is “freeze drying carbonization”, it is envisioned that any carbonization process can be utilized.

To form the S—NC carbon-based material 10, the polymer salt precursor is carbonized via a known carbonization process. A reaction between sodium thiosulfate and dilute hydrochloride acid takes place and introduces the sulfur to the carbon material. The introduction of the sulfur source to form S—NC can take place before or after, or simultaneously with, the carbonization of the precursor. In one embodiment of synthesizing S—NC, the polymer salt precursor is a poly(acrylamide-co-acrylic acid) potassium salt-sulfur precursor. In S—NC, the sulfur covalently bonds to carbon in the nitrogen-rich carbon material.

### EXAMPLES

I. Material Preparation

In a typical synthesis process for S—NC, 7.75g sodium thiosulfate (Na₂S₂O₃) was fully dissolved into 30 ml deionized water. Subsequently 1 g poly(acrylamide-co-acrylic acid) potassium salt was added slowly into the solution to form a hydrogel. This process was performed at room temperature. The dilute hydrochloride acid (3M, 20 mL) was slowly added drop by drop, with the hydrogel immediately turning yellow. After stirring for 1 h, the obtained yellow hydrogel was frozen and then freeze-dried for 72 h. The resultant yellow precursor was sealed in an alumina boat and heated inside a tubular furnace under a N₂ atmosphere at 280° C. for 1 h, followed by carbonization at 800° C. for 2 h. Finally, the produced carbon powder was then washed in dilute hydrochloric acid and deionized water to remove the inorganic impurities and dried at 80° C. for 12 h.

As a control, NC was synthesized by the similar procedure but without the addition of Na₂S₂O₃ and HCl. All the reagents were employed in their as received condition, without further purification.

II. Materials Characterization

Poly (acrylamide-co-acrylic acid) potassium salt possesses high water absorption capacity because of the hydrophilic groups (—CONH₂, —COOH and —COOK). Due to mutual repulsion between carboxylate ions fixed on the polymer chain, the polymer network expands, resulting in internal negative pressure and allowing water to enter the resin. The sodium thiosulfate will be uniformly adsorbed by poly(acrylamide-co-acrylic acid) potassium salt. After combining with diluted hydrochloric acid, elemental sulfur is formed while simultaneously giving off sulfur dioxide. During pre-heating progress in 280° C., the elemental sulfur melted and was dispersed inside the pores of the carbon precursor. In the subsequent step at 800° C., the sulfur reacts with the concurrently pyrolyzing carbon to vulcanize the structure. As a baseline, poly (acrylamide-co-acrylic acid) potassium salt was directly carbonized to obtain N-rich Carbon (NC) without any sulfur content.

The inventors observed that NC is quite dense as compared to S—NC. In S—NC, the volatilization of excess sulfur at high temperature physically breaks up the carbon, while introducing macroporosity and creating a sheet-like morphology. By contrast, a standard post-pyrolysis particulate-like morphology is formed in in the sulfur-free NC. High-resolution transmission electron microscopy (HRTEM) images confirm the amorphous internal structure of both S—NC and NC, with randomly distributed graphitic ribbons. Within the resolution of EDXS, the N, O, and S elements are all homogeneously distributed within the carbon.

X-ray diffraction (XRD) and Raman spectroscopy were employed to investigate the structure of S—NC and the NC baseline. S—NC and NC show highly broadened diffraction peaks with 26 centered at −25° . This (002) type reflection is associated with the average nearest-neighbor spacing between the highly defective graphene layers. Calculated from Bragg's Law, the average graphene layer spacing is found to slightly increase from 0.345 for NC to 0.352 nm for S—NC, both being wider than the equilibrium 3.354 nm for graphite. The Raman spectrum shows disorder-induced D band at around ˜1350 cm⁻¹ and a graphitic G band at around −1580 cm⁻¹. The D band is related to the breathing mode of k-point phonons, while the G band derives from the conjugated structure of sp² carbon. The intensity ratio of D band and G band (I_{D}/I_{G}) can be to express the degree of disorder. The value of I_{D}/I_{G} ratio of S—NC and NC are estimated to be 2.33 and 1.83. As expected, sulfur doping results in more structural defects in the carbon, which will lead to more K-active storage sites. Two weak peaks located at 359 and 478 cm⁻¹ are revealed in S—NC, corresponding to the stretching vibration and deformation of C—S and S—S bonds. The observed S—S bond is due to the trapping of small sulfur molecules inside the carbon pores, and will lead to some reversible conversion reactions that will be documented by X-ray photoelectron spectroscopy (XPS).

Nitrogen adsorption-desorption isotherms were employed to further examine the effect of sulfur doping on the porous structure of carbon materials\. Both S—NC and NC display type IV isotherms with an obvious hysteresis loop, indicating the existence of mesopores. The corresponding mesopore size distribution results were estimated by density functional theory (DFT). The Brunauer-Emmett-Teller (BET) specific surface area of S—NC is 56 m² g⁻¹, which is much lower than that of NC at 432 m² g⁻¹. This can be explained by the filling of pores by the sulfur during the carbonization process, which blocks N₂ gas access. Moreover, small sulfur molecules confined inside gas accessible pores also decreased the specific surface area. The pore size distribution results are shown in Table S1.

TABLE S1
Physical parameters for S—NC and NC materials.

| | S_{BET} | Vₜ | Pore volume | | d₀₉₂ | | XPS composition [at %] | | | | |
|---|---|---|---|---|---|---|---|---|---|---|---|
| | [m² g⁻¹]^{a)} | [cm³ g⁻¹]^{b)} | V_{<2 min} | V_{>2 min} | [nm] | I_{D}/I_{G} | C | N | O | S | Na |
| S-NC | 56 | 0.05 | 54.78 | 45.22 | 0.352 | 2.33 | 68.54 | 10.01 | 8.86 | 12.32 | 0.27 |
| NC | 432 | 0.21 | 95.11 | 4.89 | 0.345 | 1.85 | 82.43 | 8.14 | 9.43 | — | — |

^{a)}Surface area was calculated with Brunauer-Emmett-Teller (BET) method.
^{b)}The total pore volume was determined by density functional theory (DFT) method.

Table S1 indicates that S—NC possesses more macro/mesopores compared to NC. The reduction of specific surface area in S—NC is a desirable feature, since it should reduce the extent of solid electrolyte interphase (SEI) formation.

XPS was carried out to further investigate the surface chemical composition and chemical bonding in S—NC and NC. The sample S—NC displays prominent peaks corresponding to C 1s, N 1s, O 1s, S 2p and S 2s, as well as a minor peak of Na 1s. As expected, the S 2s and Na 1s peaks are absent in NC. Carbon, nitrogen and oxygen are derived from the polymer salt by self-doping, while sulfur is derived from sodium thiosulfate. The residual sodium in S—NC (0.27 at. %) can be ascribed to the addition of sodium thiosulfate. The spectrum of C 1s contains four peaks located at 284.6, 286.0, 287.7 and 291.6 eV, corresponding to the C═C/C—C, C—O/C—N/C—S, C═O and O═C—O, respectively. The oxygen of S—NC is 8.86 at. %, while it is 9.43 at. % for NC. The O 1s XPS spectra in S—NC can corresponds to four functional groups: The covalent bond of O—S (531.2 eV), C═O quinone type groups (O—I, 531.9 eV), C—OH phenol groups and/or C—O—C ether groups (O-II, 533.0 eV), and chemisorbed oxygen (COON carboxylic groups) and/or water (O-III, 536.5 eV). The nitrogen content on NC is 8.14 at. %, while it is 10.01 at. % in S—NC, suggesting that S may help to stabilize bound nitrogen during pyrolysis. In the N 1s spectrum, there are peaks at 398.6, 400.3, 401.8 and 404.3 eV. These are attributed to pyridinic nitrogen (N-6), pyrrolic or pyridonic nitrogen (N-5), graphitic nitrogen (N-Q) and oxidized nitrogen (N—O), respectively. The N moieties are dominated by N-6 and N-5 species. These can be located at the edges of the defective graphene layers, and will thereby introduce extrinsic defects and K active sites to enhance the reversible capacity. Due to the S doping, the N-Q/N-6 content increases from 4.87/38.22% for NC to 7.98/39.63% for S—NC, while N-5 and N—O decreases from 54.74/2.17% to 50.83/1.55%. This indicates that some of the N-5 was converted to N-6 and N-Q by a “ring expansion” model. The increased N-Q specie, located in the carbon layers, can enhance the electronic conductivity of carbons and facilitate charge transfer. Therefore, the fast charge performance of the carbon should be improved. The high-resolution S 2p spectrum of S—NC can be fitted into four main peaks at 163.8, 165.0, 167.9 and 169.1 eV. The two lowest energy peaks are associated with the S 2p_{3/2/}S 2p_{1/2} (33.53%/30.67%). The peaks at the higher energy are assigned to oxidized-S groups —C—SOₓ—C—, being at 29.68%. This indicates that with of S—NC, sulfur has been successfully incorporated into the carbon structure. The introduced covalently bound sulfur will offer sites for reversible bonding with K ions. Moreover, the incorporation of S into the carbon host also increases the carbon's electrical conductivity. The inventors believe the synergy of N and S co-doping enhances the potassium storage performance of S—NC.

The morphology of S—NC and NC, as discussed above, was examined by SEM, using a Hitachi S4800 operated at 15 kV. The structure of the carbons was analyzed by TEM, employing a JEOL 2010F operated at 200 kV. XRD was carried using a Bruker D8 Advance powder diffractometer, with Cu Ka radiation. The Raman spectra measurements were performed using a Lab RAM HR800, with an effective laser power on the sample of 5 mW, an excitation laser wavelength of 532 nm, and a spot size of 1 mm. The specific surface area and pore size distribution of the carbons was obtained using a Micromeritics TriStar II 3020 surface characterization analyzer. XPS analysis was performed using a Thermo ESCALAB 250X1. The carbon's electrical conductivity was measured using a multifunction digital four-probe tester (ST2253).

III. Electrochemical Analysis

To evaluate the effects of the doped-S on the electrochemical properties, both S—NC and baseline NC were analyzed as K/K⁺ half-cells. In the case of S—NC, the first scan cyclic voltammetry (CV) curve shows two irreversible cathodic peaks at about 1.50 and 0.45 V, which can be related to the formation of a solid electrolyte interphase (SEI), as well as some irreversible trapping of K ions in the bulk of the carbon. In the subsequent cycles, the two reversible redox peaks located at around 0.70/1.80 V are attributed to reversible adsorption between S-containing functional groups and potassium ions. For the case of S—NC, the close overlap of the 2^{nd} and 5^{th} CV curves reveal excellent reversibility of the sulfur related charge storage mechanisms. By contrast, these conspicuous redox peaks are missing from NC. Rather NC shows a fairly featureless redox profile comparable to other N and O rich carbons in literature. Moreover, there is more irreversible capacity for NC at cycle one, owing to its larger specific surface area and hence more SEI. In the CV's the cycle 1 Coulombic efficiency (CE) for S—NC is 66.4%, while it is 23.0% for NC. It is observed that the relatively low specific surface area of S—NC significantly improve the initial CE.

The galvanostatic charge/discharge curve of S—NC and NC was investigated at a current of 0.05 A g⁻¹. The initial discharge/charge capacities of are 1294 mAh g⁻¹/582 mAh g⁻¹ for S—NC, and 325 mAh g⁻¹/64 mAh g⁻¹ for NC. The galvanostatically measured initial CE for S—NC is 45.0%, while it is 19.7% for NC. Compared with the previously reported carbon materials for PIBs, the initial CE for S—NC is on-par, being typically better than carbons with high surface areas. This is highlighted in Table S3.

TABLE S3
Potassium storage performance of S-NC compared with previously reported materials.

| | | Cycling | | |
|---|---|---|---|---|
| Sample | Rate capacity | stability | Initial CE | |
| S-NC | 428 mAh g⁻¹ at 0.1A g⁻¹ | 140 mAh g⁻¹ | 45.0% at 0.05 | This |
| | 72 mAh g⁻¹ at 10 A g⁻¹ | after 3000 | A g⁻¹ | work |
| | | cycles at 2 | | |
| | | A g⁻¹ | | |
| Sulfur/nitrogen | 356 mAh g⁻¹ at 0.1 A g⁻¹ | 168 mAh g⁻¹ | 45.0% at 0.05 | |
| codoped carbon | 168 mAh g⁻¹ at 2 A g⁻¹ | after 1000 | A g⁻¹ | |
| nanofiber | | cycles at 2 | | |
| agerogel | | A g⁻¹ | | |
| Oxygen-Rich | 252 mAh g⁻¹ at 0.1A g⁻¹ | 111 mAh g⁻¹ | 19.0% at 0.05 | |
| Carbon | 133 mAh g⁻¹ at 10 A g⁻¹ | after 3000 | A g⁻¹ | |
| Nanosheets | | cycles at 5 | | |
| | | A g⁻¹ | | |
| N-doped | 305.7 mAh g⁻¹ at 0.05 A g⁻¹ | 119.9 mAh g⁻¹ | 49.1% at 0.05 | |
| carbon | 102.6 mAh g⁻¹ at 2 A g⁻¹ | after 1000 | A g⁻¹ | |
| | | cycles at 1 | | |
| | | A g⁻¹ | | |
| Onion-like | 179 mAh g⁻¹ at 0.1 A g⁻¹ | 111 mAh g⁻¹ | 20.0% at 0.05 | |
| carbon | 78 mAh g⁻¹ at 10 A g⁻¹ | after 1000 | A g⁻¹ | |
| | | cycles at 2 | | |
| | | A g⁻¹ | | |
| 3D nitrogen- | 309 mAh g⁻¹ at 0.1 A g⁻¹ | 137 mAh g⁻¹ | 24.3% at 0.05 | |
| doped | 111 mAh g⁻¹ at 10 A g⁻¹ | after 1000 | A g⁻¹ | |
| framework | | cycles at 2 | | |
| carbon | | A g⁻¹ | | |
| Hierarchically | 235 mAh g⁻¹ at 100 mA g⁻¹ | 65 mAh g⁻¹ | 23.7% at 0.05 | |
| Porons Thin | 64 mAh g⁻¹ at 4000 mA g⁻¹ | after 900 | A g⁻¹ | |
| Carbon Shells | | cycles at 2 | | |
| | | A g⁻¹ | | |
| Nitrogen/oxygen | 368 mAh g⁻¹ at 0.025 A g⁻¹ | 267 mA h g⁻¹ | 25% at 50 mA g⁻¹ | |
| co-doped hard | 118 mAh g⁻¹ at 3 A g⁻¹ | after 1100 | | |
| carbon | | cycles at 1 | | |
| | | A g⁻¹ | | |
| Nitrogen-doped | 293 mAh g⁻¹ at 0.02 A g⁻¹ | 102 mA h g⁻¹ | 24.45% at 0.050 | |
| carbon | 102 mAh g⁻¹ at 2 A g⁻¹ | after 500 | A g⁻¹ | |
| nanotubes | | cycles at 2 | | |
| | | A g⁻¹ | | |
| Nitrogen doped | 338 mA h g⁻¹ at 0.02 A g⁻¹ | 286 mA h g⁻¹ | 14.2% at 0.02 | |
| cup-stacked | 75 mA h g⁻¹ at 1 A g⁻¹ | after 100 | A g⁻¹ | |
| carbon tubes | | cycles at | | |
| | | 0.02 A g⁻¹ | | |
| Nitrogen | 248 mAh g⁻¹ at 0.025 A g⁻¹ | 146 mA h g⁻¹ | 49% at 0.025 | |
| doped carbon | 153 mAh g⁻¹ at 2 A g⁻¹ | after 4000 | A g⁻¹ | |
| nanofibers | | cycles at 2 | | |
| | | A g⁻¹ | | |
| Sulfur/oxygen | 230 mAh g⁻¹ at 0.05 A g⁻¹ | 108.4 mA h | 61.7% at 0.05 | |
| co-doped hard | 158 mAh g⁻¹ at 1 A g⁻¹ | g⁻¹ after | A g⁻¹ | |
| carbon | | 2000 cycles | | |
| | | at 1 A g⁻¹ | | |
| Chitin-derived | 240 mAh g⁻¹ at 0.028 A g⁻¹ | 103.4 mA h | 37.8% at 0.056 | |
| nitrogen doped | 85 mA hg⁻¹ at 1.4 A g⁻¹ | g⁻¹ after 500 | A g⁻¹ | |
| carbon | | cycles at | | |
| nanofibers | | 0.558 A g⁻¹ | | |
| Hollow carbon | 340 mAh g⁻¹ at 0.028 A g⁻¹ | 150 mA h g⁻¹ | 72.1% at 0.028 | |
| architecture | 110 mAh g⁻¹ at 0.56 A g⁻¹ | after 500 | A g⁻¹ | |
| | | cycle at | | |
| | | 0.279 A g⁻¹ | | |
| Short-range | 286.4 mAh g⁻¹ at 0.05 A g⁻¹ | 146.5 mAh g⁻¹ | 63.6% at 0.05 | |
| ordered | 144.2 mAh g⁻¹ at 1 A g⁻¹ | after 1000 | A g⁻¹ | |
| mesoporous | | cycles at 1 | | |
| carbon | | A g⁻¹ | | |
| Hyperporous | 286.4 mAh g⁻¹ at 0.05 A g⁻¹ | 210 mAh g⁻¹ | 15% at 0.1 | |
| carbon sponge | 180 mAh g⁻¹ at 1.6 A g⁻¹ | after 500 | A g⁻¹ | |
| | | cycles at 1 | | |
| | | A g⁻¹ | | |
| Sandwich-like | 345 mAh g⁻¹ at 0.1 A g⁻¹ | 250 mAh g⁻¹ | 73.0% | |
| | | after 25 | | |
| MoS₂@SnO₂@C | 86 mAh g⁻¹ at 0.8 A g⁻¹ | cycles at | at 0.05 | |
| | | 0.1 A g⁻¹ | A g⁻¹ | |
| Co₃O₄—Fe₂O₂/C | 220 mAh g⁻¹ at 0.05 A g⁻¹ | 220 mAh g⁻¹ | 60.2% at 0.05 | |
| | 278 mAh g⁻¹ at 1 A g⁻¹ | after 50 | A g⁻¹ | |
| | | cycles at | | |
| | | 0.05 A g⁻¹ | | |

For S—NC, there is no obvious voltage platform at ˜2.2V, indicating minimal K₂Sₙ (4<n<8) polysulfide formation. Electrolyte soluble polysulfide formation is well-known to be deleterious for extended cycling due to the ongoing parasitic shuttle that occurs during charging-discharging of the cell. It is expected to be significant when the S is in its “free” state, i.e. not chemically bound to the carbon, or well-confined inside the nanopores. In S—NC, the C—S covalent bonding (˜94% of total S) and the confinement of small S molecules inside the nanopores (remaining 6%), effectively eliminates polyselenides and is hence critical for avoiding capacity fade.

The rate capability of S—NC and NC was investigated through a wide current density range. The S—NC electrode delivers excellent rate capacity, with reversible capacities of 437, 369, 286, 234, 175, 114 and 72 mAh g⁻¹ (at cycle 5) at the current densities of 0.1, 0.2, 0.5, 1, 2, 5 and 10 A g⁻¹. By contrast, NC presents only 53, 42, 33, 28, 23, 20 and 18 mAh g⁻¹ at 0.1, 0.2, 0.5, 1, 2, 5 and 10 A g⁻¹. This indicates that the K⁺ active sulfur functionalities are operative at high rates; a key useful feature for KIB battery anodes, which generally underperform at fast charging. After high rate testing, when the current density is reduced back to 0.05 A g⁻¹, the capacity of S—NC is restored to 502 mAh g⁻¹. This indicates that the redox active S groups are stable at high currents. Overall, S—NC presents highly favorable rate capability as compared state-of-the-art carbonaceous anode materials for PIBs.

Long-term (3000 cycles) performance and the corresponding CE for S—NC and NC, were tested at 2 A g⁻¹. After 10 cycles, the CE of both samples increases to above 90%, indicating that a relatively stable SEI is formed. The stability of the SEI layer in carbon-based KIB anodes is known to be much more of an issue then for LIB or SIB carbon anodes. This is expected to be most severe for high surface area materials, where there is a more SEI in general. Markedly worse SEI stability has also been reported for bulk insertion of K vs. Na into undoped carbon micro-particulates. The inventors contemplate that without heteroatom dopants, most charge storage occurs by ion insertion/intercalation. In that case there would be significant volume changes at every cycle, which would destabilize the exiting SEI. Conversely the low surface area S—NC delivers an excellent reversible capacity of 141 mAh g⁻¹ after 3000 cycles, with a capacity decay only 0.01% per cycle, and 75% overall capacity retention. For both S—NC and NC the steady-state cycling CE is near 100% (per accuracy of instrument), indicting a stable SEI layer in both materials. A cycling performance comparison of S—NC versus best PIB carbons from literature is also presented in Table S3. It may be concluded that S—NC cycling stability is highly promising, being attributable to a combination of low surface area (for stable SEI) and chemical bonds of the heteroatoms with the carbon matrix.

Electrochemical impedance spectroscopy (EIS) analysis was employed to further understand the changes in S—NC and baseline NC, the samples being analyzed at cycle 1 and after 3000 cycles with an alternating current (AC) signal of 10 mV (rms) with varying frequencies (0.01-100000 Hz). The values of equivalent series resistance Rₑ (primarily related to electrolyte resistance) and charge transfer resistance R_{ct} (which contains both charge transfer and SEI contribution) can be obtained by fitting the Nyquist plots with the equivalent circuit. For S—NC, the values of R_{ct} increase from 510 Ω to 4397 Ω after 3000 cycles. For NC these values go from 1150 Ω to 11520 Ω, being consistent with its higher surface area and greater SEI formation tendency.

The Warburg impedance Z_{w} corresponds to the slope line in the low frequency region and related to the K⁺ diffusion process. In Warburg region, the values of D_{K} (diffusion coefficient of K⁺) can be calculated via Equation (1)

$${D}_{K} = \frac{{R}^{2} {T}^{2}}{2 {A}^{2} {n}^{4} {F}^{4} {C}^{2} {σ}^{2}} ( σ = \frac{{dZ}^{′}}{d {ω}^{- 1 / 2}} ) \qquad ( 1 )$$

where R, T, A, n, F, C and a are respectively, the gas constant, the absolute temperature, the active surface area of the electrode/electrolyte interface, the number of the transferred electrons, the Faraday constant, the bulk concentration and the Warburg coefficient.

The D_{K} value of S—NC electrode is 3.3×10⁻¹⁷ cm² s⁻¹, which is higher than that of NC at 1.2×10⁻¹⁷ cm² s⁻¹. After 3000 cycles, the D_{K} value of S—NC decreases to 5.7×10⁻¹⁸ cm² s⁻¹, while for NC it decreases to 2.3×10⁻¹⁸ cm² s⁻¹. These changes may be related to localized fracture of the electrodes that occur early during cycling (corresponding to early capacity losses) and hence creates a more tortuous solid-state diffusion path for the K ions.

To further electrochemically analyze the potassiation kinetics in S—NC, a series of electroanalytical tests were carried out for both materials. A series of CV tests were conducted at various scan rates (0.1 to 2.0 mV s⁻¹. The relationship between measured current (i) and scan rate (v) can be calculated by the following equation:

i=av^{b} (2)

where a and b are adjustable parameters. The values of b-exponent are determined by the slope of the log(i) versus log(v).

Accordingly, the b-value close to 1 indicates a linear time dependence of maximum reaction rate. Such charge storage process is reaction-controlled, i.e. Activation Polarization limited. While often this is attributed to a “surface capacitive process”, it does not necessarily mean EDLC charge storage. Certainly, for either S—NC or NC there is not enough electroactive surface area to have significant non-faradaic contribution to capacity. Rather, a linear time dependence can indicate a number of surface or bulk reaction-limited processes. These would be based on both faradaic charge transfer between the K ions and the S/N moieties, and on reversible adsorption of K ions at defects. Any charge-storage process which is not diffusion limited would have a time¹ rather than time^{1/2} dependence. Even classical bulk solid-state phase transformations may be reaction, rather than diffusion controlled. For time dependence, the b-value close to 0.5 and well correlates to a diffusion-controlled process. With graphite, this is the classic solid-state diffusion-limited ion intercalation staging reaction. However, there is not enough graphitic order in either S—NC or NC as to allow for orderly K staging. Therefore, a time dependence will signal some other form of Concentration Polarization process, such as K ion insertion into energetically favorable but geometrically random bulk sites. Especially for K ion insertion into both graphic and non-graphitic carbons, solid-state limited process are reported to be kinetically sluggish. The calculated cathodic b-values are 0.87 for S—NC and 0.81 for NC, indicating the kinetics being closer to reaction-controlled. The calculated anodic b-values are 0.78 for S—NC and 0.88 for NC, also confirming a primarily reaction-controlled process.

The reaction controlled versus solid-state diffusion controlled contributions to the total reversible capacity in S—NC and NC were further quantitatively analyzed using the following equation:

i(v)=i_{React}+i_{Diff}k₁v+k₂v^{1/2} (3)

with k₁ and k₂ as adjustable parameters related to reaction and bulk diffusion processes, respectively. By plotting i/v^{1/2} vs. v^{1/2}, the values of k₁ and k₂ can be determined from the slope and intercept. For S—NC, the ratio of reaction controlled capacity contribution to diffusion-controlled capacity contribution increase from 27% at 0.1 mV s⁻¹, to 31% at 0.2 mV s⁻¹, 39% at 0.5 mV s⁻¹, 50% at 1 mV s⁻¹ and 63% at 2 mV s⁻¹. For NC, the ratio of reaction controlled capacity contribution to diffusion-controlled capacity contribution increase from 45% at 0.1 mV s⁻¹, to 52% at 0.2 mV s⁻¹, 61% at 0.5 mV s⁻¹, 69% at 1 mV s⁻¹ and 77% at 2 mV s⁻¹. A higher relative fraction of kinetic controlled processes for NC is consistent with its high surface area which is expected to contribute to the total capacity through ion reversible absorption (not EDLC) at surface heteroatom groups and defect sites.

Galvanostatic Intermittent Titration Technique (GITT) was employed to analyze the K ion diffusivity (D_{K}) in the S—NC and NC specimens through the entire range of relevant voltages. The GITT data of S—NC and NC were recorded at a constant current density of 25 mA g⁻¹ for an interval of 30 min followed by 180 min relaxation in the first cycle.

For NC, at potassiation voltages of 2.6, 1.2, 0.5, 0.2 and 0.15 V, the values of D_{K} are 2.7×10⁻¹¹, 2.2×10⁻¹², 1.8×10⁻¹², 1.9×10⁻¹³, 6.0×10⁻¹⁴ cm² s⁻¹. For NC potassiated to the same voltages, the D_{K} values are 3.6×10⁻¹², 7.3×10⁻¹³, 4.3×10⁻¹³ 1.9×10⁻¹³ and 2.3×10⁻¹³ cm² s⁻¹, respectively. The lower solid-state diffusivity of K in S—NC near its terminal potassiation stage may be related to increased site occupancy: At and below 0.2 V, a higher fraction of possible diffusion sites in S—NC are already filled with K (due to the overall higher capacity achieved), not allowing for facile motion of additional ions. During the depotassiation process of S—NC, at 0.2, 0.5, 1, 1.6 and 2.2 V, the D_{K} values are 2.0×10⁻¹¹, 4.9×10⁻¹², 6.1×10⁻¹², 9.2×10⁻¹³, 6.1×10⁻¹³ cm² s⁻¹. For NC these values are 2.4×10⁻¹², 1.0×10⁻¹², 1.2×10⁻¹², 2.0×10⁻¹³ and 2.3×10⁻¹³ cm² s⁻¹, respectively. This indicates that depotassiation D_{K} of S—NC is a factor of 2.7-8.3 higher than for NC. Interestingly, during depotassation there is no cross-over in diffusivity values, implying that that further analysis is needed of the low voltage phenomena.

To obtain in-depth insight into the potassiation/depotassiation mechanisms in S—NC, post-mortem XPS analysis was carried out. The specimens were disassembled at different states of charge during the first and the second cycle. All the disassembling, storage and transfer steps were performed in inert Ar atmosphere, ensuring minimal oxidation-related artifacts. At cycle one, specimens are analyzed in their pristine state (I), at 1 V (II), 0.2 V (III), 0.001 V (IV), 1.5 V (V), and 3 V (VI). At cycle two, specimens were analyzed at 3 V (VI) i.e. same analysis as cycle one, at 0.001 V (VII), and 3 V (VIII). The current density employed for this analysis was 0.05 A g⁻¹.

At a potassiation voltage of 1 V, peaks at 293.2 eV and at 296 eV are present in K 2p spectra. This indicates the presence of K—C bonds. Since S—NC is too disordered to allow for orderly K intercalation, the K—C bonds can be attributed to adsorption of K ions at various carbon chemical and structural defects. When the potassiation voltage reaches 0.2 V, the above two peaks shift to a lower binding energy (E_{b}), while increasing in overall intensity. At 0.001V, these peaks shift to the lowest binding energy while achieving their maximum intensity. During the subsequent depotassiation process, the two peaks recover to higher E_{b} values while reducing in their intensity. However, even at 3 V some K—C peak intensity is still present. This is due to limited irreversible trapping of K in the carbon matrix, as discussed earlier. During cycle two potassiation the binding energy of the K 2p peaks likewise decreases, while their intensity increases. The reverse trend is observed during cycle two depotassiation. These largely reversible changes in E_{b} indicate that the potassiation reactions with the carbon matrix are reversible.

The evolution of S chemical bonds with K was also analyzed by XPS. The S 2p peak at initial state can be divided into four different peaks located at 163.8, 165.0, 167.9 and 169.1 eV, which were assigned to S 2p3/2, S 2p1/2 and —S—Oₓ—S, respectively. At a potassiation voltage of 1 V, it can be seen that the S 2p3/2 and S 2p1/2 peaks still exist. Moreover, two additional peaks appear at 161.3/162.6 eV, being related to the formation of sulfides (K₂Sₓ). The three peaks located in the higher E_{b} can be related to thiosulfate and sulfate. When the potassiation voltage reaches to 0.2 V, the intensity of S 2p3/2 and S 2p1/2 peaks decreases and those two peaks disappear. At the terminal voltage of 0.001 V, the two distinct peaks at 161.3/162.8 eV assigned to sulfides (K₂S), indicating the step reactions of S and K. In the fully potassiated state, the E_{b} of S 2p negatively shifted to a lower value at fully potassiation state, indicating that the strong interaction of K⁺ and S atoms lead to a lower valence state of S. At cycle one depotassiation voltage of 1.5 V, there are no obvious changes in the S-related spectra versus when in the terminally potassiated state. This indicates that minimal K—S reaction occurs in this voltage range during the first anodic charge. During depotassiation to higher voltages, the intensity of S 2p gradually increases, while the intensity of the sulfur-oxygen functional group gradually decreases. At 3V, the binding energy of S 2p3/2 and S 2p1/2 shifts to 163.2 and 164.8 eV, indicating reversible oxidation of S. However these energy values remain lower than those of the pristine sample, which were at 163.8 and 165.0 eV, indicating that some S reduction is not reversible. The peak at 162.1 eV is assigned to the residual sulfide species (S²⁻), which would arise from the incomplete oxidation reaction. The peaks for —SO₃H— and other sulfur oxygen functional groups are also stronger than in the pristine sample. This is also ascribed to irreversible electrochemical reactions at cycle 1. At cycle two potassiation to 0.001 V, the two distinct K₂S peaks at 161.3 /162.8 eV reappear, as well as do the thiosulfate and sulfate peaks. In addition, the S²⁻ and S 2p peaks replace K₂S peaks and —SO₃H/S═O peaks appear after cycle two depotassiation.

The XPS results reveal what occurs during the potassiation-depotassiation process for the various N moieties. While the sodiation reactions with N functional groups have been considered prior, to the inventors' knowledge there has not been a systematic analysis of potassiation reactions. At cycle one potassiation to 1 V, the N-6, N-5 and N-Q start to react with K⁺, while N—O does not react with K. When the potassiation reaches 0.2 V, the N-5 and N-6 groups react with K⁺ and are no longer discernable. The moiety N-Q is not fully reacted, while N—O just begins to react. At the terminal 0.001 V, all the N configurations appear to have reacted. The Eb of N-6, N-5, N-Q, and N—O negatively shifts from the original values of 398.8, 400.3, 401.3, and 403.5 eV to 398.3, 399.2, 400.3, and 403.4 eV, respectively. This indicates that charge was transferred from K to the N-dopants, to form K-protonated N structures in the carbon matrix. During the subsequent depotassiation process, some of the nitrogen-containing functional group do not return to the original state. Specifically, N-6 and N-5 don't reappear, rather forming a product that could not be readily identified. However, the N—O and N-Q groups do reform upon depotassiation. This may be observed in the cycle one depotassiation 1.5 V and 3 V spectra.

At cycle two potassiation to 0.001 V, the N-5/K and N-6/K peaks nearly have no change, while N-Q and N—O all transform into N-Q/K and N—O/K, respectively. At depotassiation to 3V, the N-Q and N—O peaks reappear, while N-5/K, N-6/K and N-Q/K still exist. According to the above analysis, the reaction of N with K⁺ is a gradual process. The reaction of N-6/5 to another configuration appears irreversible. However at least a portion of the reaction of N-Q and N—O is fully reversible in the sense that these functional groups are recovered.

In summary, the N and N—O related peaks undergo a series of complex shifts that indicate both reversible and irreversible changes to the functional group structure. It is important to note that the irreversible changes described above do not necessarily mean that the capacity is lost, only that the functional groups do not revert to their original configuration. Although the electrochemical potassiation reaction is largely reversible, the type N-C bonds that exist afterward are not the fully same as in the starting material.

The electrochemical performance of S—NC and baseline NC vs. K/K⁺ was examined by employing CR 2032 coin-type cells, which were assembled in an Ar-filled glovebox. To prepare the working electrode, active materials (75 wt. %), conductive material (carbon black, 15 wt. %), and binder (polyvinylidene fluoride (PVDF), 10 wt. %) were dissolved in N-methyl-2-pyrrolidinone to form a slurry, which was pasted onto a copper foil current collector. After being vacuum-dried at 80° C. for 10 h, the electrodes were cut into circular pieces with a diameter of 15 mm, and an average mass loading of ˜1.0 mg cm⁻². A solution of 0.8M KPF₆ in ethylene carbonate (EC) and diethyl carbonate (DEC) (1:1 by volume) was employed as the electrolyte. Potassium foil was employed as counter electrodes. Galvanostatic charge-discharge measurements were conducted in the range of 0.001-3.0 V, using a Land CT2001A, battery tester. CV, EIS and GITT analysis were performed using a Gamry Interface 1000. All electrochemical measurements were carried out at room temperature.

As will be apparent to those skilled in the art, various modifications, adaptations and variations of the foregoing specific disclosure can be made without departing from the scope of the invention claimed herein. The various features and elements of the invention described herein may be combined in a manner different than the specific examples described or claimed herein without departing from the scope of the invention. In other words, any element or feature may be combined with any other element or feature in different embodiments, unless there is an obvious or inherent incompatibility between the two, or it is specifically excluded.

References in the specification to “one embodiment,” “an embodiment,” etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described. The terms “embodiment”, “aspect” and “example” may be used interchangeably.

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The term “and/or” means any one of the items, any combination of the items, or all of the items with which this term is associated. The phrase “one or more” is readily understood by one of skill in the art, particularly when read in context of its usage.

Each numerical or measured value in this specification is modified by the term “about”. The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by the skilled artisan, all numbers, including those expressing quantities of reagents or ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

What is claimed is:

1. An electrode for an electrochemical energy storage device, comprising:
a carbon-based material comprising at least two heteroatoms, wherein at least one of the at least two heteroatoms is covalently bonded to carbon in the carbon-based material.

2. The electrode according to claim 1, wherein the at least two heteroatoms are selected from a group consisting of boron (B), oxygen (O), sulfur (S), phosphorus (P) and nitrogen (N).

3. The electrode according to claim 1, wherein the at least two heteroatoms are sulfur (S) and nitrogen (N).

4. The electrode according to claim 3, wherein sulfur is covalently bonded to carbon in the carbon-based material.

5. The electrode according to claim 4 comprising 75% retention of initial capacity after 3000 cycles.

6. The electrode according to claim 3, wherein carbon-based material comprises 12.3 at. % S and 10.0 at. % N.

7. The electrode according to claim 1, wherein the electrochemical energy storage device is a potassium ion battery (KIB).

8. The electrode according to claim 1 being an anode.

9. A carbon-based material comprising:
at least two heteroatoms,
wherein at least one of the at least two heteroatoms is covalently bonded to carbon in the carbon-based material.

10. The carbon-based material according to claim 9, wherein the at least two heteroatoms are selected from a group consisting of boron (B), oxygen (O), sulfur (S), phosphorus (P) and nitrogen (N).

11. The carbon-based material according to claim 9, wherein the at least two heteroatoms are sulfur (S) and nitrogen (N).

12. The carbon-based material according to claim 11, wherein sulfur is covalently bonded to carbon in the carbon-based material.

13. The carbon-based material according to claim 11, further comprising:
12.3 at. % S; and
10.0 at. % N.

14. The carbon-based material according to claim 11, further comprising macropores and mesopores, wherein at least a portion of the macropores and mesopores are filled with sulfur.

15. A process for synthesizing a heteroatom-containing carbon material, the process comprising:
carbonizing a polymer salt precursor to form a nitrogen-rich carbon material; and
introducing sulfur to the nitrogen-rich carbon material by a reaction between sodium thiosulfate and dilute hydrochloride acid, thereby synthesizing the heteroatom-containing carbon material.

16. The process according to claim 15, wherein the polymer salt precursor is a poly(acrylamide-co-acrylic acid) potassium salt-sulfur precursor.

17. The process according to claim 16, wherein the sulfur covalently bonds to carbon in the nitrogen-rich carbon material.
